(19) United States
(12) Patent Application Publication
(10) Pub. No.: US 2007/0065120 A1
(43) Pub. Date: Mar. 22, 2007

(54) RECORDING DEVICE

(75) Inventor: Shingo Nozawa, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/470,505

(22) Filed: Sep. 6, 2006

(30) Foreign Application Priority Data
Sep. 20, 2005 (JP) 2005-271872

(51) Int. Cl. H04N 5/00

(52) U.S. Cl. 386/126

(57) ABSTRACT

A recording device which includes a recorder for recording image data on a recording medium, and a controller for controlling the recorder to perform finalizing processing for recording predetermined data on the recording medium on which the image data is recorded and also for displaying one or more images corresponding to the image data recorded on the recording medium on a display unit while the finalizing processing is being performed.

### BACKGROUND OF THE INVENTION

1. Field of the Invention

The present invention relates to recording devices, and more particularly, to finalizing processing executed on recording media on which image data is recorded.

2. Description of the Related Art

Recording devices for recording image data on optical discs, such as digital versatile discs (DVDs), are known. Further, there are various physical formats and application formats depending on the types of DVD.

Among the various types of DVD, DVD discs, such as DVD-recordable (DVD-R) and DVD-rewritable (DVD-RW) discs, have high compatibility with general DVD video, and such DVD discs can be played back in DVD players if they are subjected to finalizing processing (for example, see Japanese Patent Laid-Open No. 2003-87708, and corresponding US Publication No. 2003/0002861). That is, in order to play back DVDs on which images are recorded in general DVD players, finalizing processing is required.

Finalizing processing includes processing, such as writing predetermined management information onto DVDs that have image data recorded thereon, writing null data into unrecorded areas on DVDs, and generating operation menu images used for DVD players, for example.

It takes several minutes to several tens of minutes to perform such finalizing processing. Accordingly, the user has to wait for a long time until finalizing processing finishes, which may irritate the user.

### SUMMARY OF THE INVENTION

The present invention provides a recording device that enables a user to enjoy his/her time while finalizing processing is being executed on a recording medium.

According to an aspect of the present invention, a recording device is provided which includes a recording unit configured to record image data on a recording medium; and a control unit configured to control the recording unit to perform finalizing processing for recording predetermined data on the recording medium on which the image data is recorded, and also for displaying one or more images corresponding to the image data recorded on the recording medium on a display unit while the finalizing processing is being performed.

According to another aspect of the present invention, the control unit may sequentially display first frames located at the heads of a plurality of scenes of the image data recorded on the recording medium while the finalizing processing is being performed. According to another aspect of the present invention, the control unit may display the first frames of the image data at intervals in proportion to recording periods of the plurality of scenes corresponding to the first frames.

According to yet another aspect of the present invention, the control unit finishes displaying all of the first frames of the image data upon completing the finalizing processing. Moreover, according to another aspect of the present invention, the control unit may sequentially display a plurality of frames extracted one by one at predetermined intervals from the image data recorded on the recording medium.

Additionally, according to another aspect of the present invention, the control unit may display the plurality of frames in an order corresponding to a recording order in which the image data is recorded on the recording medium. Furthermore, according to another aspect of the present invention, the control unit may update the frame to be displayed in accordance with a progress of the finalizing processing.

Still further, according to another aspect of the present invention, the recording device may further include a playback unit for playing back the image data recorded on the recording medium, wherein the control unit generates image data to be displayed during the finalizing processing by using the image data played back by the playback unit. And, according to yet another aspect of the present invention, the control unit may sequentially display a plurality of frames among the image data recorded on the recording medium while updating the plurality of frames, and also generates menu image data indicating a list of the plurality of frames and controls the recording unit to record the generated menu image data on the recording medium during the finalizing processing.

Additionally, according to another aspect of the present invention, the finalizing processing includes at least one of writing predetermined management information onto the recording medium having image data recorded thereon, writing null data into unrecorded areas on the recording medium, and generating operation menu images utilized in recorded medium players. And still further according to yet another aspect of the present invention, the recording device may be configured to perform the finalizing processing to increase compatibility between recording mediums having differing formats.

Moreover, according to another aspect of the present invention, a method is provided which may be performed in a recording device for finalizing processing executed on recording media on which image data is recorded. The recording device includes a recording unit and a control unit. Here, the method includes recording image data on a recording medium; controlling the recording unit to perform finalizing processing for recording predetermined data on the recording medium on which the image data is recorded; and displaying one or more images corresponding to the image data recorded on the recording medium on a display unit while the finalizing processing is being performed.

And still further, according to yet another aspect of the present invention, a computer readable medium is provided containing computer-executable instructions to be executed method performed in a recording device for finalizing processing executed on recording media on which image data is recorded, the recording device including a recording unit and a control unit. The medium includes computer-executable instructions for recording image data on a recording medium; computer-executable instructions for controlling the recording unit to perform finalizing processing for recording predetermined data on the recording medium on which the image data is recorded; and computer-executable instructions for displaying one or more images corresponding to the image data recorded on the recording medium on a display unit while the finalizing processing is being performed.

Further features and aspects of the present invention will become apparent from the following description of exemplary embodiments with reference to the attached drawings.

### BRIEF DESCRIPTION OF THE DRAWINGS

FIG. 1 is a block diagram illustrating an exemplary configuration of a recording device according to a first embodiment of the present invention.

FIG. 2 illustrates an exemplary display screen during finalizing processing according to an aspect of the present invention.

FIG. 3 is a flowchart illustrating exemplary finalizing processing according to an aspect of the present invention.

FIG. 4 illustrates an example of the extraction of images to be displayed on a display screen according to an aspect of the present invention.

FIG. 5 illustrates another example of the extraction of images to be displayed on a display screen according to an aspect of the present invention.

FIG. 6 is a block diagram illustrating an exemplary configuration of a recording device according to a second embodiment of the present invention.

### DESCRIPTION OF THE EMBODIMENTS

Numerous exemplary embodiments of the present invention are now herein described below with reference to the accompanying drawings.

### First Exemplary Embodiment

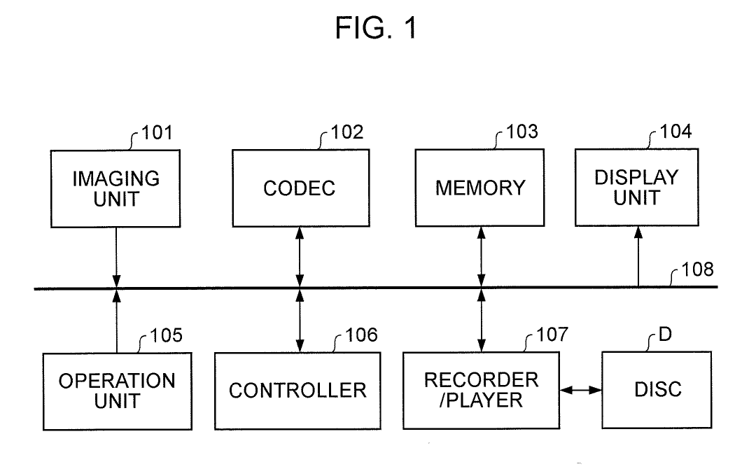

FIG. 1 illustrates an exemplary configuration of a recording device according to a first embodiment of the present invention. The recording device includes an imaging unit 101 for imaging a subject and outputting resulting image data, a codec 102 for coding captured image data according to a moving picture experts group (MPEG) method or for decoding played back image data, a memory 103, a display unit 104 for displaying, not only captured images and played back images, but also various types of other images, such as menu screens and finalizing screens, an operation unit 105 having various switches, a controller 106, a recorder/player 107 for writing data onto or reading data from a disc D, and a data bus 108. The disc indicated by D is an optical disc medium, such as a DVD-R.

The recording device shown in FIG. 1 is operated by the user operating the operation unit 105 and by the controller 106 controlling the elements forming the recording device in response to the operation performed by the user. More specifically, when an imaging operation is started, the imaging unit 101 images a subject and converts the captured image into image data, and outputs the image data to the codec 102. The codec 102 codes the image data to convert it into an MPEG stream, and temporarily stores it in the memory 103. The recorder/player 107 reads the MPEG stream data stored in the memory 103 at a predetermined time and records the read data on the disc D. Such an operation is repeated so that image streams are sequentially written onto the disc D.

After finishing the imaging operation, the user instructs the recording device to perform finalizing processing through the operation unit 105 so that the disc D can be played back in a DVD player. In response to the instruction to perform finalizing processing, the controller 106 prepares required data, such as predetermined management information and operation menu images used for a DVD player. Then, the controller 106 controls the recorder/player 107 to write the prepared data onto the disc D and write null data into unrecorded areas of the disc D.

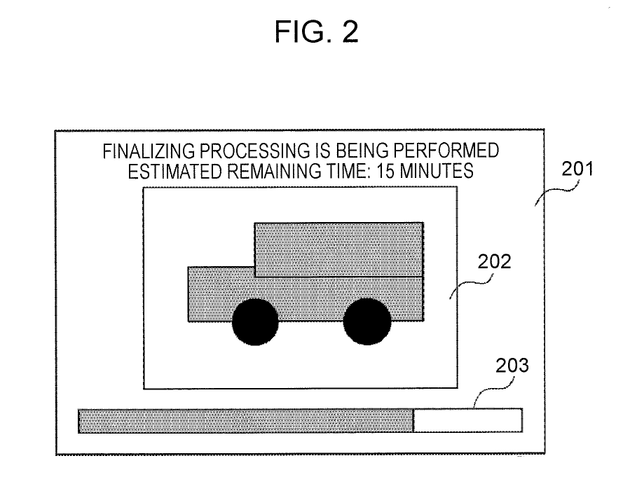

During the finalizing processing, the controller 106 displays a display screen 201 shown in FIG. 2 on the display unit 104 to provide information concerning the remaining time to finish finalizing processing to the user. In FIG. 2, the display screen 201 includes an image display area 202 and a progressive bar display area 203. The progressive bar is a bar informing the user in real time of the progress of the finalizing processing in relation to the total time required for the finalizing processing.

In the image display area 202, still images corresponding to video streams recorded on the disc D are sequentially displayed. For example, images, such as the first frame of each scene, frames extracted at regular intervals, and frames specified by the user, can be displayed.

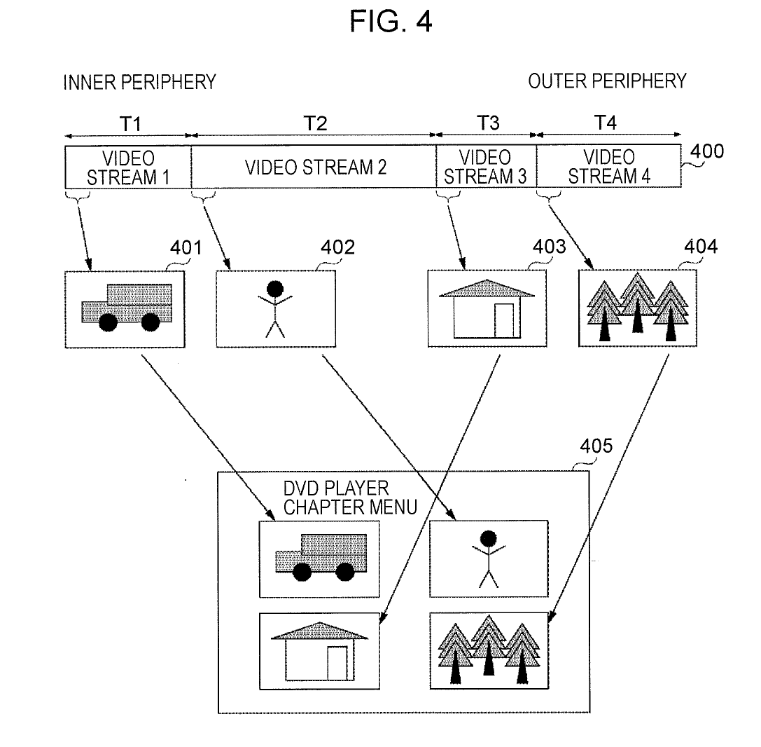

FIG. 4 illustrates an example of the relationship between video streams 400 recorded on the disc D and the images displayed in the image display area 202. In FIG. 4, video streams 1 through 4 indicate data of a series of scenes recorded during the imaging operation. Intra-coded (I) pictures (or images) 401, 402, 403, and 404, which are the first frames of the scenes of the video streams 1, 2, 3, and 4, respectively, recorded on the disc D are sequentially played back from the disc D, and are then decoded and displayed.

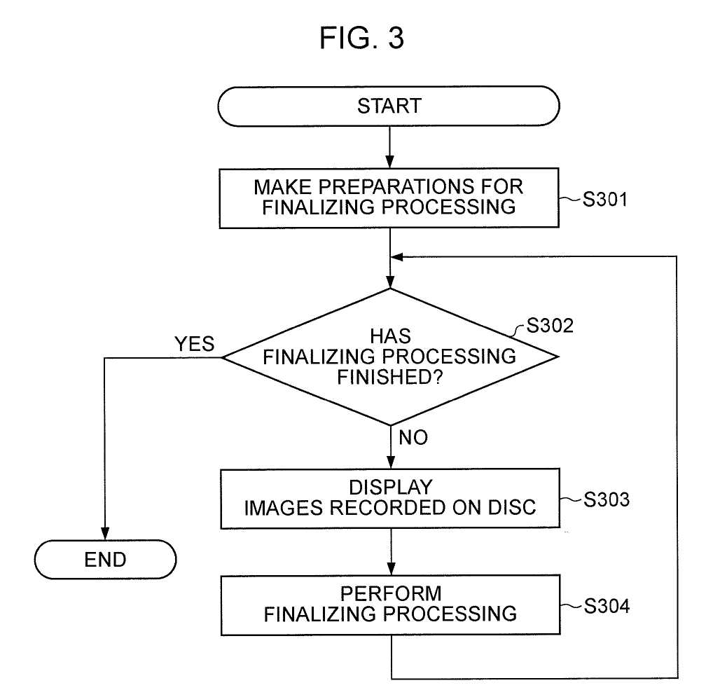

The above-described processing is performed by the controller 106 by controlling the elements forming the recording device. FIG. 3 is a flowchart illustrating exemplary finalizing processing performed by the controller 106. In response to an instruction to perform finalizing processing from the operation unit 105, in step S301, the controller 106 makes preparations for finalizing processing. More specifically, the controller 106 prepares various data to be written onto the disc D during the finalizing processing by, for example, detecting information concerning image streams recorded on the disc D, generating predetermined management information, and generating a file system table. The controller 106 also detects unrecorded areas to be filled with null data, and creates a list of video streams as a menu screen used for a DVD player.

The controller 106 then determines in step S302 whether the finalizing processing has finished, and if the finalizing processing has not finished, steps S303 and S304 are repeated until the finalizing processing is finished.

In step S303, the controller 106 controls the recorder/player 107 to play back part of each scene of an image stream recorded on the disc D, for example, to read the first frame data of each scene. The first frame data read by the recorder/player 107 is decoded by the codec 102 and is stored in the memory 103. Then, the image data of the first frames stored in the memory 103 are displayed in the image display area 202 of the display unit 104 as still images. It is noted that the reading, decoding, and storing of the first image data of the individual scenes in the memory 103 may be performed every time a display image is updated, or may be executed collectively on the amount of decoded data that can be stored in the memory 103.

In step S304, finalizing processing is performed by writing various data prepared in step S301 into the disc D and also by writing null data into unrecorded areas of the disc D. The writing of prepared data and null data is performed in units of sectors forming the disc D, and is repeated until it is determined in step S302 that finalizing processing has finished.

The display image may be updated repeatedly on the display screen of the image display area 202 at equal time intervals until finalizing processing is finished, or may be displayed at time intervals in proportion to the recording intervals of the video streams T1, T2, T3, and T4 shown in FIG. 4.

By dividing the total finalizing time among the display images on the basis of the recording interval ratio and by displaying the images according to the distributed time intervals, the display of the images selected from the image data recorded on the disc D can be finished simultaneously with the completion of finalizing processing.

The display images may be updated as desired or some images displayed earlier may be played back as desired by the user, thereby enabling the user to feel good while operating the device. Also, if many video streams are recorded on the disc D, an image may be extracted from every predetermined number of scenes, instead of extracting an image from every scene.

In the processing shown in FIG. 3, still image data is generated for displaying images and are stored in the memory 103 in step S303. Alternatively, all image data may be prepared and stored in the memory 103 during preparations for finalizing processing in step S301.

Generally, in preparations for finalizing processing, a list of video streams, such as a list 405 shown in FIG. 4, is generated as a menu screen used for a DVD player. Accordingly, in this embodiment, a list of images generated for a menu screen can be used as images to be displayed during finalizing processing.

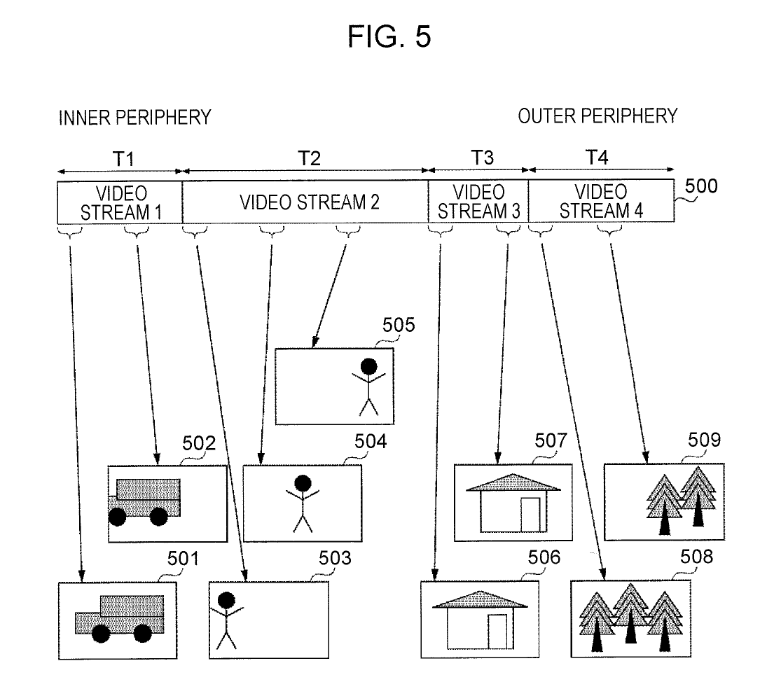

FIG. 5 illustrates another example of the relationship between video streams recorded on the disc D and images to be displayed in the image display area 202. In FIG. 5, one or more I-pictures 501 through 509 are extracted at predetermined intervals from the heads of coded streams corresponding to video streams 1 through 4 recorded in a recording area 500 of the disc D. Then, the extracted, decoded I-pictures 501 through 509 are sequentially displayed.

With this configuration, during finalizing processing, images are displayed on the display screen as if frame advancing were performed, instead of simply displaying still images at the heads of coded stream. This enables the user to understand the details of video streams and to enable the user to feel good while operating the device. Accordingly, the user can wait until finalizing processing has finished while enjoying the scenes that the user has photographed.

### Second Exemplary Embodiment

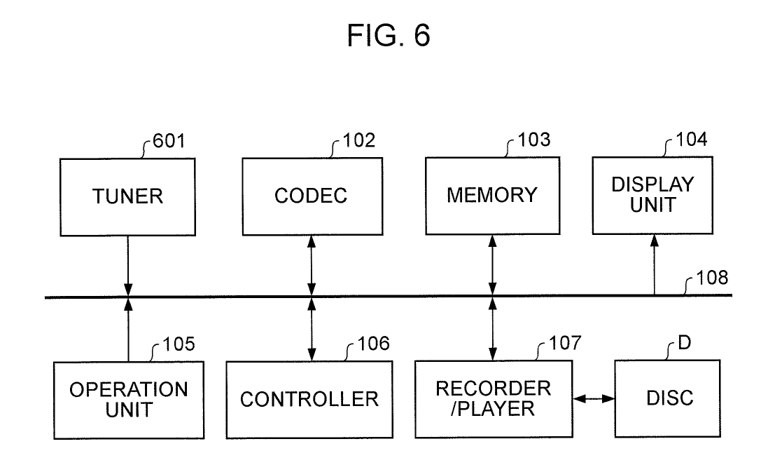

FIG. 6 is a block diagram illustrating an exemplary configuration of a recording device according to a second embodiment of the present invention. The recording device includes a tuner 601 instead of the imaging unit 101 shown in FIG. 1. Otherwise, the components are similar to the recording device from FIG. 1, and thus, a description is not repeated. The recording device from FIG. 6 is operated by the user operating the operation unit 105 and by the controller 106 controlling the blocks forming the recording device in response to the operation.

More specifically, when a recording operation is started, the tuner 601 receives a broadcast signal of a preset channel and sends the received signal to the codec 102. The codec 102 converts the video data contained in the received broadcast signal into MPEG streams, and stores them in the memory 103. The recorder/player 107 then reads out the MPEG streams stored in the memory 103 and records them on the disc D.

The functions of the blocks 102 through 108 shown in FIG. 6 are equivalent and or similar to those of the counterparts of the first embodiment shown in FIG. 1, and can also display decoded images during finalizing processing. With this configuration, a digested program recorded on the disc D can be displayed while finalizing processing is being performed on the disc D, thereby enabling the user to enjoy his/her time while sequentially seeing the digest video images.

In the foregoing embodiments, the devices for recording data on or playing back data from optical discs, such as DVD-Rs, have been discussed by way of example. The present invention is also applicable to devices for recording image data on other types of recording media that require finalizing processing.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2005-271872 filed Sep. 20, 2005, which is hereby incorporated by reference herein in its entirety.

What is claimed:

1. A recording device comprising:
a recording unit configured to record image data on a recording medium; and
a control unit configured to control the recording unit to perform finalizing processing for recording predetermined data on the recording medium on which the image data is recorded, and also for displaying one or more images corresponding to the image data recorded on the recording medium on a display unit while the finalizing processing is being performed.

2. The recording device according to claim 1, wherein the control unit sequentially displays first frames located at the heads of a plurality of scenes of the image data recorded on the recording medium while the finalizing processing is being performed.

3. The recording device according to claim 2, wherein the control unit displays the first frames of the image data at intervals in proportion to recording periods of the plurality of scenes corresponding to the first frames.

4. The recording device according to claim 2, wherein the control unit finishes displaying all of the first frames of the image data upon completing the finalizing processing.

5. The recording device according to claim 1, wherein the control unit sequentially displays a plurality of frames extracted one by one at predetermined intervals from the image data recorded on the recording medium.

6. The recording device according to claim 5, wherein the control unit displays the plurality of frames in an order corresponding to a recording order in which the image data is recorded on the recording medium.

7. The recording device according to claim 6, wherein the control unit updates the frame to be displayed in accordance with a progress of the finalizing processing.

8. The recording device according to claim 1, further comprising a playback unit for playing back the image data recorded on the recording medium, wherein the control unit generates image data to be displayed during the finalizing processing by using the image data played back by the playback unit.

9. The recording device according to claim 1, wherein the control unit sequentially displays a plurality of frames among the image data recorded on the recording medium while updating the plurality of frames, and also generates menu image data indicating a list of the plurality of frames and controls the recording unit to record the generated menu image data on the recording medium during the finalizing processing.

10. The recording device according to claim 1, wherein the finalizing processing includes at least one of writing predetermined management information onto the recording medium having image data recorded thereon, writing null data into unrecorded areas on the recording medium, and generating operation menu images utilized in recorded medium players.

11. The recording device according to claim 1, wherein the recording device is configured to perform the finalizing processing to increase compatibility between recording mediums having differing formats.

12. A method performed in a recording device for finalizing processing executed on recording media on which image data is recorded, the recording device including a recording unit and a control unit, the method comprising:
recording image data on a recording medium;
controlling the recording unit to perform finalizing processing for recording predetermined data on the recording medium on which the image data is recorded; and
displaying one or more images corresponding to the image data recorded on the recording medium on a display unit while the finalizing processing is being performed.

13. The method according to claim 12, further including sequentially displaying first frames located at the heads of a plurality of scenes of the image data recorded on the recording medium while the finalizing processing is being performed.

14. The method according to claim 13, further including displaying the first frames of the image data at intervals in proportion to recording periods of the plurality of scenes corresponding to the first frames.

15. The method according to claim 13, wherein the control unit finishes displaying all of the first frames of the image data upon completing the finalizing processing.

16. The method according to claim 12, further including sequentially displays a plurality of frames extracted one by one at predetermined intervals from the image data recorded on the recording medium.

17. The method according to claim 16, further including displaying the plurality of frames in an order corresponding to a recording order in which the image data is recorded on the recording medium.

18. The method according to claim 17, further including updating the frame to be displayed in accordance with a progress of the finalizing processing.

19. The method according to claim 12, wherein the recording device further includes a playback unit for playing back the image data recorded on the recording medium, the method further including,
generating image data to be displayed during the finalizing processing by using the image data played back by the playback unit.

20. The method according to claim 12, further including,
sequentially displaying a plurality of frames among the image data recorded on the recording medium while updating the plurality of frames; and
generating menu image data indicating a list of the plurality of frames and controls the recording unit to record the generated menu image data on the recording medium during the finalizing processing.

21. The method according to claim 12, wherein the finalizing processing includes at least one of writing predetermined management information onto the recording medium having image data recorded thereon, writing null data into unrecorded areas on the recording medium, and generating operation menu images utilized in recorded medium players.

22. The method according to claim 12, wherein the recording device is configured to perform the finalizing processing to increase compatibility between recording mediums having differing formats.

23. A computer readable medium containing computer-executable instructions to be executed method performed in a recording device for finalizing processing executed on recording media on which image data is recorded, the recording device including a recording unit and a control unit, the medium comprising:
computer-executable instructions for recording image data on a recording medium;
computer-executable instructions for controlling the recording unit to perform finalizing processing for recording predetermined data on the recording medium on which the image data is recorded; and
computer-executable instructions for displaying one or more images corresponding to the image data recorded on the recording medium on a display unit while the finalizing processing is being performed.

24. The computer readable medium according to claim 23, further including computer-executable instructions for sequentially displaying first frames located at the heads of a plurality of scenes of the image data recorded on the recording medium while the finalizing processing is being performed.

25. The computer readable medium according to claim 24, further including computer-executable instructions for displaying the first frames of the image data at intervals in proportion to recording periods of the plurality of scenes corresponding to the first frames.

26. The computer readable medium according to claim 24, wherein the control unit finishes displaying all of the first frames of the image data upon completing the finalizing processing.

27. The computer readable medium according to claim 23, further including computer-executable instructions for sequentially displaying a plurality of frames extracted one by one at predetermined intervals from the image data recorded on the recording medium.

28. The computer readable medium according to claim 23, further including computer-executable instructions for displaying the plurality of frames in an order corresponding to a recording order in which the image data is recorded on the recording medium.

29. The computer readable medium according to claim 24, further including computer-executable instructions for updating the frame to be displayed in accordance with a progress of the finalizing processing.

30. The computer readable medium according to claim 23, wherein the recording device further includes a playback unit for playing back the image data recorded on the recording medium, the medium further including,
computer-executable instructions for generating image data to be displayed during the finalizing processing by using the image data played back by the playback unit.

31. The computer readable medium according to claim 23, further including,
computer-executable instructions for sequentially displaying a plurality of frames among the image data recorded on the recording medium while updating the plurality of frames; and
computer-executable instructions for generating menu image data indicating a list of the plurality of frames and controls the recording unit to record the generated menu image data on the recording medium during the finalizing processing.

32. The computer readable medium according to claim 23, wherein the finalizing processing includes computer-executable instructions for at least one of writing predetermined management information onto the recording medium having image data recorded thereon, writing null data into unrecorded areas on the recording medium, and generating operation menu images utilized in recorded medium players.

33. The computer readable medium according to claim 23, wherein the recording device is configured to perform the finalizing processing to increase compatibility between recording mediums having differing formats.
